(19) United States
(12) Patent Application Publication
(10) Pub. No.: US 2026/0370336 A1
(43) Pub. Date: Nov. 19, 2026

(54) SYSTEM AND METHOD FOR TIME-VARYING SPIRAL PARAMETER MODULATION FOR DATA ENCODING

(71) Applicant: Eliyah Omar El-Moreh, kelowna (CA)

(72) Inventor: Eliyah Omar El-Moreh, kelowna (CA)

(21) Appl. No.: 19/639,124

(22) Filed: Apr. 3, 2026

(30) Foreign Application Priority Data
May 15, 2025 (CA) 3273914
Mar. 19, 2026 (CA) 3305435

(51) Int. Cl. H04B 10/50; H04B 10/61

(52) U.S. Cl. CPC H04B 10/504; H04B 10/616

(57) ABSTRACT

A communication method and system are disclosed in which information is encoded by dynamically varying, over time, a pitch-to-radius ratio κ of a spiral phase structure imparted to a coherent electromagnetic wave. The spiral phase structure is characterized by κ, which defines a geometric pitch characteristic of the spiral and serves as a primary information-bearing variable distinct from a topological charge or orbital angular momentum mode index. Input data is encoded by varying κ over time and transmitting the resulting encoded electromagnetic wave through a communication channel. At a receiver, temporal variations of κ are estimated from spatial, interferometric, or modal characteristics of the received wave, and encoded information is recovered by mapping the estimated variations to corresponding symbols. In certain embodiments, κ is mapped to a dimensionless control parameter λ. The method and system support binary, multi-level, and continuous modulation formats in optical, guided-wave, free-space, or hybrid communication systems.

### BACKGROUND

Modern communication systems commonly encode information using amplitude, frequency, phase, or polarization of an electromagnetic wave. In optical communication systems, additional work has been done using structured light, including beams carrying orbital angular momentum (OAM), in which a wavefront exhibits a helical or spiral phase structure. Such approaches may provide additional degrees of freedom for multiplexing and signal separation.

Existing spiral- or OAM-based communication methods generally rely on selection among discrete spiral modes or topological charge states. In many such systems, the spiral characteristic is treated as a fixed or quasi-static property of the transmitted beam, with information being assigned to one mode or another. Although this may increase channel capacity, such systems do not fully exploit the possibility of using a spiral-related geometric parameter itself as a time-varying modulation variable.

There remains a need for a communication method in which a spiral characteristic of an electromagnetic wave is dynamically varied over time in response to input data, such that the spiral characteristic functions as a modulation parameter analogous to, but distinct from, conventional amplitude, frequency, phase, or polarization modulation. There is also a need for systems capable of generating, transmitting, receiving, and decoding such time-varying spiral modulation in a practical communication architecture.

In particular, existing systems do not appear to exploit a geometric pitch-related characteristic of a spiral phase structure, such as a pitch-to-radius ratio or a derived dimensionless parameter, as the primary time-varying information-bearing quantity. Accordingly, there remains a need for systems and methods that use dynamic variation of such a spiral characteristic as a standalone modulation mechanism, implementable across optical, free-space, guided-wave, and integrated photonic communication systems.

### SUMMARY OF THE INVENTION

The invention provides a communication method and system in which information is encoded by dynamically varying, over time, a pitch-to-radius ratio κ of a spiral phase structure of an electromagnetic wave. An electromagnetic wave is generated, imparted with a spiral phase structure characterized by κ, and modulated by varying κ in accordance with input data, wherein κ is the primary information-bearing variable and is not limited to selection of an orbital angular momentum mode index or topological charge of the spiral phase structure. The resulting wave is transmitted through a communication channel and decoded at a receiver based on estimated temporal variations of κ.

In certain embodiments, κ is defined as a ratio of a pitch characteristic p to a radius characteristic r of the spiral phase structure, such that κ=p/r. In certain further embodiments, κ is mapped to a dimensionless control parameter λ, wherein encoding and recovering are performed using λ as a modulation variable, and wherein λ=κ²/(1+κ²). The invention supports binary, multi-level, continuous, and hybrid modulation schemes by switching κ between discrete values, selecting κ from among multiple values, or varying κ continuously over time.

The invention further provides transmitter, controller, and receiver architectures configured to implement such modulation. In some embodiments, the spiral phase structure is generated or varied using a spatial light modulator, tunable phase device, metasurface, diffractive optical element, waveguide structure, or integrated photonic circuit. In some embodiments, a receiver estimates κ using interferometric analysis, mode decomposition, spatial sampling, or other signal recovery techniques.

By using temporal variation of κ, a geometric pitch-to-radius ratio, as the primary information-bearing quantity, rather than merely selecting among fixed spiral states or discrete orbital angular momentum mode indices, the invention provides a distinct modulation architecture applicable to optical, free-space, guided-wave, integrated photonic, and other electromagnetic communication systems.

### BRIEF DESCRIPTION OF THE DRAWINGS

FIG. 1 is a schematic diagram of a communication system configured to encode information by dynamically varying a pitch-to-radius ratio κ of a spiral phase structure of an electromagnetic wave, the system including a signal source, a spiral modulation unit, a controller, a transmission channel, and a receiver.

FIG. 2 is a block diagram illustrating a modulation process in which input data is mapped to time-varying values of κ, including in some embodiments optional mapping to a dimensionless control parameter λ.

FIG. 3 is a graph showing exemplary temporal variation of κ as a function of time, including representative binary, multi-level, and continuous modulation formats.

FIG. 4 is a schematic diagram of an embodiment in which a spiral phase structure and its associated pitch-to-radius ratio κ are generated and varied over time using a spatial light modulator driven by a controller.

FIG. 5 is a schematic diagram of a receiver configured to estimate temporal variation of κ from a received electromagnetic wave and to recover encoded information by mapping estimated values of κ to corresponding information symbols.

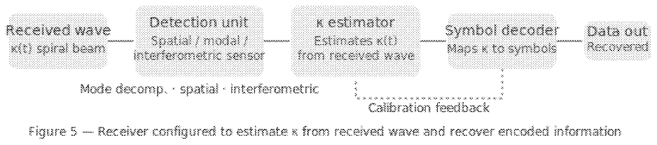

FIG. 6 is a schematic diagram of an interferometric detection arrangement in which a received spiral-modulated wave is combined with a reference wave to estimate κ from geometric or phase characteristics of the resulting interference pattern.

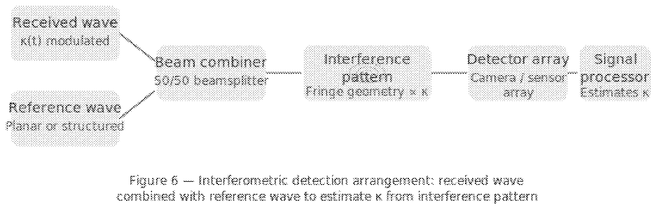

FIG. 7 is a flow diagram illustrating a method of transmitting information, including generating a coherent electromagnetic wave, imparting a spiral phase structure characterized by κ, encoding input data by dynamically varying κ over time, transmitting the wave through a communication channel, and recovering the input data at a receiver by estimating κ.

FIG. 8 is a flow diagram illustrating a method of receiving information, including receiving a signal having a spiral phase structure with time-varying κ, estimating κ as a function of time from spatial, interferometric, or modal characteristics of the received wave, and decoding information by mapping estimated values of κ to corresponding information symbols.

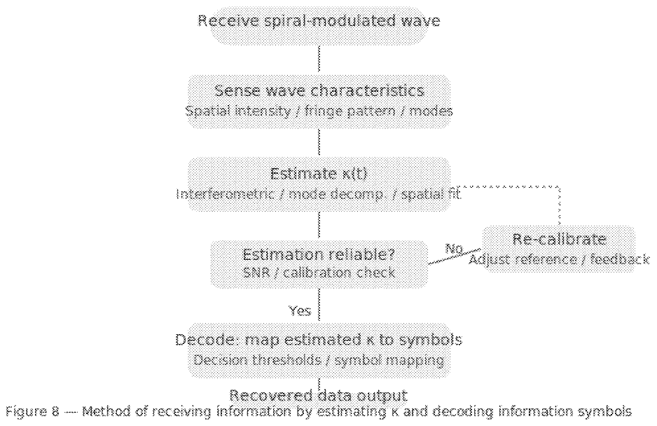

### DETAILED DESCRIPTION OF THE INVENTION

The present invention relates to systems and methods for encoding, transmitting, and recovering information by dynamically varying, over time, a pitch-to-radius ratio κ of a spiral phase structure of an electromagnetic wave. Unlike systems that assign information to fixed spiral states, discrete orbital angular momentum modes, or topological charge states, the present invention uses κ, a continuous geometric parameter, as the primary information-bearing modulation variable. The invention therefore differs from communication approaches based on selection of an orbital angular momentum mode index or topological charge.

### 1. General System Architecture

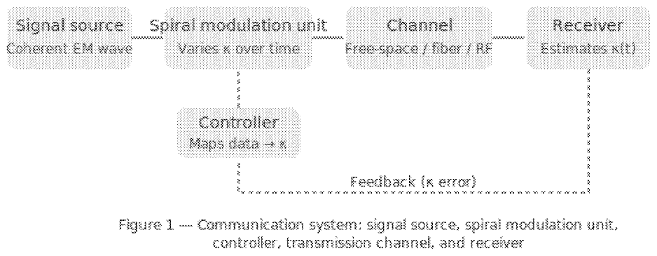

In one embodiment, the system comprises a source configured to generate a coherent electromagnetic wave, a spiral modulation unit configured to impart to the electromagnetic wave a spiral phase structure characterized by a pitch-to-radius ratio κ, a control unit configured to vary κ over time in accordance with input data such that κ serves as the primary information-bearing variable, a transmission channel, and a receiver configured to estimate κ from the received wave and recover the transmitted information. An exemplary overall architecture is illustrated in FIG. 1.

The electromagnetic wave may comprise an optical wave, infrared wave, radio-frequency wave, microwave signal, terahertz signal, or another propagating electromagnetic carrier. In preferred embodiments, the electromagnetic wave is a coherent optical beam generated by a laser source. However, the invention is not limited to optical implementations.

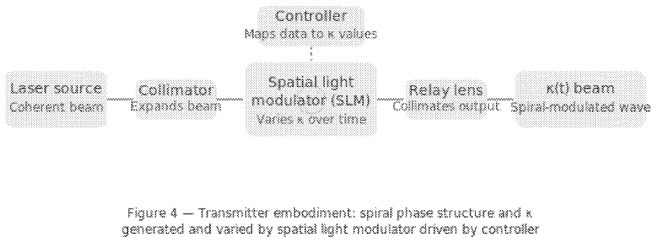

The spiral modulation unit may comprise any device capable of producing or controlling a spiral phase structure in the electromagnetic wave. Examples include a spatial light modulator, a tunable phase mask, a spiral phase plate, a deformable optical element, a diffractive optical element, a metasurface, a waveguide structure, an integrated photonic device, or an equivalent structure. An exemplary embodiment employing a spatial light modulator is illustrated in FIG. 4. In some embodiments, the spiral phase structure may be produced directly at the source. In other embodiments, the spiral phase structure may be imparted downstream from the source.

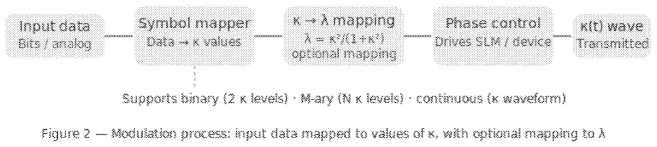

The control unit receives input data and maps the input data to target values of κ, as illustrated in FIG. 2. The control unit then drives the spiral modulation unit so as to vary κ over time in accordance with the mapped data values. The resulting output wave thereby carries information in the temporal evolution of κ.

### 2. Pitch-to-Radius Ratio κ and Optional Control Parameter λ

In the present invention, the primary information-bearing quantity is a geometric parameter associated with a pitch characteristic of a spiral phase structure. In preferred embodiments, this quantity is a pitch-to-radius ratio κ of the spiral phase structure, defined as a ratio of a pitch characteristic p to a radius characteristic r, such that κ=p/r. κ is not limited to selection of a discrete orbital angular momentum mode index or topological charge. Rather, κ is varied continuously or in discrete steps over time as the primary modulation variable.

In certain embodiments, κ is mapped to a dimensionless control parameter λ that may be used for modulation control and receiver-side decoding. This relationship maps non-negative values of κ to a bounded interval and may provide a numerically stable control variable for implementation. The invention is not limited to this specific representation, and equivalent parameters or derived control values correlated with spiral pitch behavior may also be used, provided that the transmitted information is encoded through time-varying κ as described herein.

κ may be controlled directly as a geometric property of the spiral wavefront, or indirectly through a derived control parameter such as λ. Regardless of implementation form, the invention requires that κ correspond to a geometric pitch-related characteristic of the spiral phase structure and be varied over time in accordance with input data.

In some embodiments, κ may be varied while preserving one or more other properties of the wave, including amplitude, frequency, phase offset, polarization, handedness, or orbital angular momentum mode, which may remain fixed or may be co-modulated. In some embodiments, the orbital angular momentum mode index may be held fixed while κ varies. In other embodiments, the orbital angular momentum mode index may also vary, provided that κ remains the primary information-bearing variable. Accordingly, κ modulation may be used alone or in combination with conventional modulation formats to increase aggregate channel capacity.

In one implementation, the relationship between λ and κ is given by: λ=κ²/(1+κ²), where κ is a pitch-to-radius ratio. In certain embodiments, κ may be expressed as a ratio of a pitch characteristic p to a radius characteristic r, such that: κ=p/r. The invention is not limited to this specific representation, and equivalent parameters or derived control values correlated with spiral pitch behavior may also be used.

### 3. Encoding and Modulation

Input data may comprise binary data, multi-level symbols, analog information, control signals, metadata, synchronization patterns, or combinations thereof. The control unit maps the input data to corresponding values of κ.

In one embodiment, binary symbols are represented by two discrete values of κ. For example, a first value of κ may represent binary “0,” and a second value of κ may represent binary “1.” In another embodiment, three or more discrete values of κ may correspond to multiple symbol states, thereby enabling multi-level signaling. In another embodiment, κ may vary continuously over time according to a waveform derived from an analog or hybrid input signal.

κ may be updated at fixed symbol intervals, variable symbol intervals, asynchronously, or continuously. The time dependence may follow stepwise transitions, ramp functions, oscillatory functions, coded sequences, pulse-shaped transitions, filtered transitions, or other temporal profiles. In some embodiments, temporal variation of κ may itself constitute a waveform carrying information in magnitude, rate of change, timing, trajectory, or combinations thereof.

In some embodiments, modulation may be performed in serial fashion. In other embodiments, multiple data streams may be encoded concurrently using temporal variation of κ together with one or more additional signal dimensions, including amplitude, phase, frequency, polarization, or spatial mode, such that the wave carries information simultaneously in κ and in at least one additional modulation format. 4. Controller Operation

The control unit may comprise hardware, software, firmware, or combinations thereof. In one embodiment, the control unit receives digital input data from a communication interface and generates control signals for a spiral modulation device. In another embodiment, the control unit comprises a lookup table, a digital signal processor, programmable logic, a field-programmable gate array, a microcontroller, or analog drive circuitry configured to convert input symbols into corresponding κ commands.

The control unit may generate static commands for individual symbols or continuous control trajectories that define a desired time evolution of κ. In some embodiments, the control unit may compensate for distortion, alignment error, thermal drift, component nonlinearity, transmission impairments, or receiver feedback by adjusting commanded values of κ in real time so as to maintain a calibrated mapping between transmitted κ values and recovered information symbols.

In some implementations, the control unit may receive conventionally modulated data or conventional symbol streams and convert them into time-varying κ-based modulation for transmission. This allows the invention to interface with existing communication infrastructure while introducing κ modulation as an additional information-bearing layer.

### 5. Transmission Channel

The modulated wave may be transmitted through any communication channel capable of carrying the electromagnetic wave while preserving sufficient information to permit estimation of temporal variation of κ. The channel may comprise free-space propagation, optical fiber, ring-core fiber, hollow-core fiber, a waveguide, an integrated photonic pathway, a radio-frequency transmission path, or a hybrid channel.

In optical embodiments, the channel may include free-space links, guided-wave links, or mixed links having both free-space and guided segments. In some embodiments, the channel may further include optical elements configured to preserve, relay, reshape, or correct the spiral structure during propagation. Such elements may include adaptive optics, mode-matching optics, beam-shaping elements, dispersion compensators, relays, or alignment subsystems.

The invention is not limited to channels that preserve a perfect spiral geometry. Rather, it is sufficient that the received signal retain measurable information from which temporal variation of κ may be inferred or estimated.

### 6. Receiver and Recovery of Data

The receiver is configured to estimate temporal variation of κ and to recover encoded information therefrom. In one embodiment, the receiver comprises a detection unit configured to sense spatial, interferometric, modal, or geometric characteristics of a received wave. A processing unit then estimates κ as a function of time and maps estimated values of κ to transmitted data.

In some embodiments, the receiver estimates κ by combining the received wave with a reference wave and analyzing geometric or phase characteristics of a resulting interference pattern. In some embodiments, the receiver performs mode decomposition and derives κ from relative amplitudes or phases of decomposed modal components. In some embodiments, the receiver spatially samples an intensity distribution of the received wave and fits the sampled distribution to a parametric model of the spiral phase structure to extract κ.

Estimated values of κ may then be mapped to binary values, symbol values, analog levels, or other information representations. In certain embodiments, the receiver may employ timing recovery, equalization, filtering, error correction, decision thresholds, adaptive calibration, or feedback to a transmitter-side controller for real-time κ correction.

### 7. Interferometric Embodiments

In a preferred embodiment, the receiver includes an interferometric detection arrangement. A received spiral-modulated wave is combined with a reference wave, and the resulting interference pattern is analyzed to estimate κ as a function of time. Because variation in κ alters the spatial interference structure, fringe geometry, and phase distribution of the combined field, interferometric analysis may provide a sensitive means for estimating κ from the received wave.

The reference wave may be planar, spherical, spiral, partially structured, or otherwise selected to enhance sensitivity to changes in the transmitted value of κ. Detection may be performed using a photodetector array, an image sensor, a mode sorter, an integrated photonic detector, or an equivalent sensing structure. Signal processing may then extract one or more features of the observed interference pattern and map those features to the transmitted data.

### 8. Example Symbol Mapping

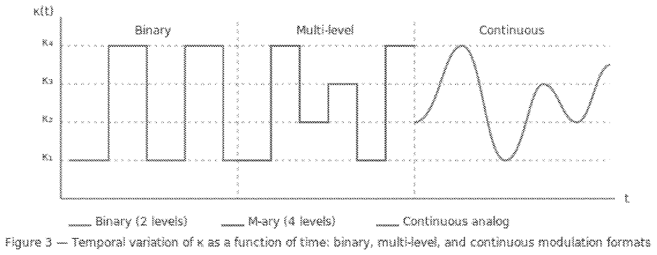

By way of example only, a binary communication format may be established in which a first value of κ corresponds to a first binary state and a second value of κ corresponds to a second binary state, as shown in the binary waveform of FIG. 3. In a multi-level communication format, three or more discrete values of κ may correspond to distinct symbols, as shown in the multi-level waveform of FIG. 3. In another example, κ may vary continuously over time according to a waveform derived from an analog or hybrid input signal, with a receiver reconstructing said waveform from estimated temporal variation of κ, as shown in the continuous waveform of FIG. 3. These examples are illustrative and do not limit the invention to any particular number of levels, parameter range, symbol alphabet, or mapping scheme.

### 9. Combination With Other Modulation Formats

In some embodiments, time-varying κ modulation may be used as a standalone communication format. In other embodiments, time-varying κ modulation may be combined with one or more additional modulation dimensions, including amplitude modulation, frequency modulation, phase modulation, polarization modulation, wavelength multiplexing, or mode multiplexing, such that the wave carries information concurrently in κ and in at least one additional modulation format.

For example, a wave may carry information both in a conventional amplitude or phase domain and in temporal variation of κ. In a further embodiment, κ may be modulated using an M-ary symbol alphabet with M≥4 in combination with amplitude modulation or phase modulation, such that the wave carries two or more independent information dimensions simultaneously. Separate channels may also be distinguished by wavelength or polarization, while each channel independently carries κ modulation.

### 10. Practical Implementations

In one optical implementation, a coherent laser beam is directed to a spatial light modulator controlled by a digital controller. The controller maps input data to target values of κ and updates the spatial light modulator so as to generate a transmitted beam having time-varying κ, as illustrated in FIG. 4. A receiver at a remote location estimates κ from the transmitted beam and recovers the input data from estimated temporal variation of κ.

In one integrated embodiment, a photonic integrated circuit includes one or more phase-control elements configured to produce a spiral phase structure and to vary κ over time in accordance with input data. The transmitted signal propagates through a waveguide or free-space coupling interface and is detected by a corresponding integrated or discrete receiver.

In one hybrid embodiment, a communication system accepts conventional input data from an existing modem, processor, or communication network, converts said data into κ-based modulation, transmits the resulting signal through a spiral-compatible link, and converts recovered information back into a conventional data format after reception and decoding.

### 11. Variations

The invention is not limited to a particular spiral geometry, a particular mathematical definition of κ or λ, or a particular implementation technology. Various changes, substitutions, and modifications may be made without departing from the spirit and scope of the invention. For example, κ may be controlled directly as a geometric property of a spiral wavefront, or indirectly through derived control variables or equivalent observable quantities correlated with spiral pitch behavior. Likewise, transmission and detection may occur in optical, radio-frequency, guided-wave, free-space, integrated, or mixed-domain systems. All such variations are intended to fall within the scope of the appended claims.

### EXAMPLE EMBODIMENTS

The following embodiments are provided for illustration only and are not intended to limit the scope of the invention.

### Embodiment 1: Optical Free-Space Transmission Using a Spatial Light Modulator

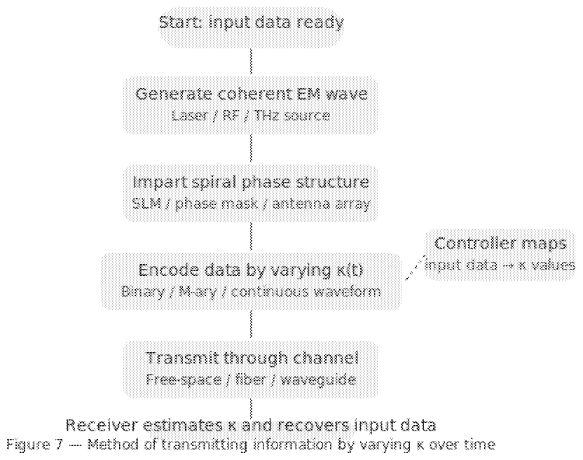

In one embodiment, a communication system comprises a coherent optical source, a spatial light modulator, a control unit, a free-space transmission channel, and a receiver. The coherent optical source generates a beam that is directed to the spatial light modulator. The control unit receives input data and maps the input data to corresponding values of κ, the pitch-to-radius ratio of the spiral phase structure. The spatial light modulator is driven in time so as to impart a spiral phase structure to the beam and dynamically vary κ in accordance with the mapped input data, as illustrated in FIG. 4. The resulting modulated beam is transmitted through free space to the receiver, which estimates κ as a function of time and recovers the transmitted information. The corresponding method steps are illustrated in FIG. 7.

### Embodiment 2: Binary Signaling Using Two Values of κ

In one embodiment, the input data is binary data. A first value of κ represents binary “0,” and a second value of κ represents binary “1.” A controller switches the spiral modulation unit between said values in time with an input bitstream, as shown in the binary waveform of FIG. 3. At the receiver, κ is estimated at each symbol interval and mapped to the corresponding binary state, thereby reconstructing the original binary data.

### Embodiment 3: Multi-Level Symbol Encoding

In one embodiment, the communication system uses three or more discrete values of κ, each corresponding to a distinct symbol, as illustrated by the multi-level waveform in FIG. 3. The controller maps groups of bits to selected κ values, thereby creating a multi-level signaling format. A receiver estimates κ at successive symbol intervals and maps the estimated values to the corresponding symbols.

### Embodiment 4: Continuous κ Modulation

In one embodiment, κ varies continuously over time according to an analog or hybrid waveform derived from input information, as illustrated by the continuous waveform in FIG. 3. A modulation unit generates an electromagnetic wave whose spiral phase structure evolves continuously in response to the control signal. At the receiver, the time-varying κ is estimated and interpreted as the transmitted waveform or corresponding information signal.

### Embodiment 5: λ-Based Implementation

In one embodiment, κ is mapped to a dimensionless control parameter λ=κ²/(1+κ²), where κ=p/r is the pitch-to-radius ratio of the spiral phase structure. A control unit maps input data to corresponding values of λ and drives a spiral modulation device to generate an electromagnetic wave having a time-varying λ. A receiver estimates κ and/or λ from the received signal and recovers the encoded information therefrom.

### Embodiment 6: Interferometric Receiver

In one embodiment, the receiver comprises an interferometric detection system. A received spiral-modulated wave is combined with a reference wave, producing an interference pattern that varies as a function of the transmitted value of κ. A detector captures said interference pattern, and a processing unit extracts geometric or phase features of the pattern, estimates κ, and maps the estimated value to the corresponding information symbol, thereby recovering the transmitted data.

### Embodiment 7: Integrated Photonic Implementation

In one embodiment, the modulation system is implemented in an integrated photonic device. The device includes one or more phase-control elements configured to generate a spiral phase structure and to vary κ over time in response to input data. The modulated signal propagates through an on-chip or chip-coupled waveguide system and is detected by an integrated or external receiver.

### Embodiment 8: Hybrid Communication Interface

In one embodiment, the system interfaces with a conventional communication architecture. Conventional digital data from a modem, processor, or communication network is received by a control unit and converted into time-varying κ commands. The resulting κ-modulated signal is transmitted through a communication channel, and the recovered information is converted back into a conventional data representation after reception and decoding.

### Embodiment 9: Combined Modulation Architecture

In one embodiment, temporal variation of κ is used together with at least one additional modulation format selected from amplitude modulation, phase modulation, frequency modulation, polarization modulation, wavelength multiplexing, or mode multiplexing. Thus, a single signal may carry information simultaneously in both conventional signal dimensions and in a time-varying κ.

### Embodiment 10: Non-Optical Electromagnetic Implementation

In one embodiment, the invention is implemented using a non-optical electromagnetic carrier, including a microwave, radio-frequency, or terahertz signal. An antenna array, phased array, or wavefront-shaping aperture is configured to produce a helical phase distribution exp(i·θ) across the wavefront cross-section, with θ being the azimuthal angle. κ is varied over time by adjusting the radial scaling of said helical phase distribution in accordance with input data. A receiver estimates κ(t) as a continuous-valued parameter—rather than detecting a discrete mode index—and recovers the transmitted information therefrom.

### Embodiment 11: Combined κ and Amplitude/phase Modulation (M-ary)

In one embodiment, the invention is used in combination with at least one additional modulation format. For example, κ is modulated using an M-ary symbol alphabet with M≥4, in combination with amplitude modulation or phase modulation of the electromagnetic wave, such that the wave carries two or more independent information dimensions simultaneously. The controller maps groups of input bits jointly to a selected value of κ and a selected amplitude or phase, thereby increasing net bits per symbol relative to single-dimension modulation. A corresponding receiver estimates κ and demodulates the amplitude or phase independently, then combines both measurements to recover the full symbol.

### Embodiment 12: Real-Time Feedback Calibration

In one embodiment, the system implements a closed-loop calibration architecture. The receiver estimates κ from the received signal and computes an estimation error relative to the expected transmitted value. This error is returned to the controller as a feedback signal. The controller adjusts the target values of κ commanded to the spiral modulation unit in real time to compensate for channel-induced distortion, thermal drift, or alignment error. This feedback loop maintains a calibrated mapping between transmitted κ values and recovered information symbols, improving robustness in practical communication channels.

It will be understood that the foregoing embodiments are illustrative only. Features described in connection with one embodiment may be used in combination with features of another embodiment. The invention is therefore not limited to the specific embodiments described herein, but encompasses variations falling within the scope of the appended claims.

### Advantages

The invention provides a number of technical advantages. It enables information to be encoded in temporal variation of κ—a geometric pitch-to-radius ratio of a spiral phase structure—thereby providing a modulation mechanism distinct from conventional amplitude, frequency, phase, and polarization modulation, and from selection among discrete OAM modes or topological charge states.

The invention also provides flexibility across binary, multi-level, continuous, analog, and hybrid signaling formats. It may be implemented using various modulation technologies, including spatial light modulators, tunable phase devices, metasurfaces, diffractive elements, and integrated photonic structures. It is further adaptable to free-space, guided-wave, and hybrid channels.

In some embodiments, the invention supports interferometric, mode decomposition, and spatial sampling techniques for estimation of κ(t) and recovery of encoded data. The invention may also be combined with conventional modulation and multiplexing methods, using κ as an orthogonal information-bearing dimension alongside amplitude, frequency, phase, polarization, or wavelength. Furthermore, because κ variation may not be recoverable by receivers designed only for conventional modulation formats, the invention may provide an additional layer of signal separation or isolation in applicable deployments.

1. A method of transmitting information, comprising:
generating a coherent electromagnetic wave;
imparting a spiral phase structure to the electromagnetic wave, the spiral phase structure being characterized by a pitch-to-radius ratio κ defining a geometric pitch characteristic of the spiral;
encoding input data by dynamically varying κ over time in accordance with the input data, wherein κ is the primary information-bearing variable and is not limited to selection of an orbital angular momentum mode index or topological charge of the spiral phase structure;
transmitting the encoded electromagnetic wave through a communication channel; and
recovering the input data at a receiver by estimating temporal variations of κ from the received wave and mapping the estimated variations to the input data.

2. The method of claim 1, wherein κ is defined as a ratio of a pitch characteristic p to a radius characteristic r of the spiral phase structure, such that κ=p/r.

3. The method of claim 2, wherein κ is mapped to a dimensionless control parameter λ, wherein encoding and recovering are performed using λ as a modulation variable, and wherein λ and κ satisfy: λ=κ²/(1+κ²).

4. The method of claim 1, wherein encoding comprises switching κ between a first value and a second value at successive symbol intervals, wherein the first value represents a first binary state, and the second value represents a second binary state.

5. The method of claim 1, wherein encoding comprises selecting κ from among three or more discrete values at each symbol interval, each discrete value corresponding to a distinct symbol representing two or more bits of the input data.

6. The method of claim 1, wherein encoding comprises varying κ continuously over time according to a waveform derived from an analog or hybrid input signal.

7. The method of claim 1, further comprising:
mapping the input data to κ values using a control unit; and
driving a modulation device to produce corresponding time-varying spiral characteristics.

8. The method of claim 7, wherein the modulation device comprises a spatial light modulator, a tunable phase element, a metasurface, a diffractive optical element, or an integrated photonic device.

9. A method of receiving information, comprising:
receiving a signal comprising a coherent electromagnetic wave having a spiral phase structure characterized by a pitch-to-radius ratio κ that varies over time in accordance with encoded information, wherein κ is the primary information-bearing variable and is not limited to selection of an orbital angular momentum mode index or topological charge of the spiral phase structure;
estimating a value of κ as a function of time by analyzing spatial, interferometric, or modal characteristics of the received wave; and
decoding the encoded information by mapping the estimated time-varying values of κ to corresponding information symbols.

10. The method of claim 9, wherein estimating κ comprises combining the received wave with a reference wave to generate an interference pattern, and extracting a value of κ from geometric or phase characteristics of the interference pattern.

11. A communication system, comprising:
a transmitter configured to generate an electromagnetic wave;
a spiral modulation unit configured to impart a spiral phase structure to the electromagnetic wave and to vary a pitch-to-radius ratio κ of the spiral phase structure over time, wherein κ is the primary information-bearing variable and is not limited to selection of an orbital angular momentum mode index or topological charge of the spiral phase structure;
a controller configured to map input data to target values of κ and to drive the spiral modulation unit to produce the corresponding spiral phase structure at each symbol interval; and
a receiver configured to estimate κ from a received signal and to recover the input data by mapping estimated values of κ to corresponding information symbols.

12. The communication system of claim 11, wherein the transmitter is configured to receive an input signal modulated according to at least one of amplitude modulation, frequency modulation, or phase modulation, and to convert the input signal into κ-based spiral modulation for transmission.

13. The communication system of claim 11, wherein the spiral modulation unit comprises a spatial light modulator, a tunable phase element, a metasurface, a diffractive optical element, or an integrated photonic device.

14. The communication system of claim 11, wherein the receiver comprises an interferometric detection arrangement configured to combine the received signal with a reference wave to determine temporal variation of κ.

15. The method of claim 9, wherein estimating κ comprises performing mode decomposition on the received wave and deriving κ from the relative amplitudes or phases of the decomposed modal components.

16. The method of claim 9, wherein estimating κ comprises spatially sampling an intensity distribution of the received wave and fitting the sampled distribution to a parametric model of the spiral phase structure to extract κ.

17. The method of claim 1, further comprising simultaneously modulating the electromagnetic wave according to at least one additional modulation format selected from amplitude modulation, frequency modulation, phase modulation, polarization modulation, and wavelength multiplexing, such that the electromagnetic wave carries information concurrently in κ and in the at least one additional modulation format.

18. The method of claim 1, wherein the coherent electromagnetic wave comprises a microwave, radio-frequency, or terahertz signal, wherein the spiral phase structure is imposed by an antenna array, phased array, or wavefront-shaping aperture configured to produce a helical phase distribution across a wavefront cross-section, wherein κ is varied over time by adjusting a radial scaling of said helical phase distribution in accordance with the input data, and wherein recovering comprises estimating κ(t) at the receiver as a continuous-valued parameter rather than detecting a discrete mode index.

19. The communication system of claim 11, wherein the controller is further configured to receive feedback from the receiver indicative of an estimation error in κ, and to adjust the target values of κ commanded to the spiral modulation unit in real time to compensate for channel-induced distortion, thermal drift, or alignment error, thereby maintaining a calibrated mapping between transmitted κ values and recovered information symbols.

20. The method of claim 17, wherein κ is modulated using an M-ary symbol alphabet with M≥4, in combination with at least one of amplitude modulation or phase modulation of the electromagnetic wave.
